(19) United States
(12) Patent Application Publication
(10) Pub. No.: US 2020/0336883 A1
(43) Pub. Date: Oct. 22, 2020

(54) INTELLIGENT TERMINAL EMERGENCY COMMAND SYSTEM

(71) Applicant: Beijing Yutian Technology Co.Ltd, Beijing (CN)

(72) Inventor: Libao YAN, Beijing (CN)

(21) Appl. No.: 16/687,679

(22) Filed: Nov. 18, 2019

(30) Foreign Application Priority Data
Apr. 17, 2019 (CN) 201910306897.3

(51) Int. Cl. H04W 4/90; H04L 12/58; G06Q 50/26

(52) U.S. Cl. CPC H04W 4/90; G06Q 50/265; H04L 51/04; H04L 51/38

(57) ABSTRACT

The present invention discloses an intelligent terminal emergency command system, which is based on the B2C architecture mode, establishes an adapter on its server side, encapsulates service layer interface of the business system with EJB, provides APP application supporting the front end and realizes the service layer interface of available business functions to realize the emergency reporting, video uploading, daily zero report and emergency disposal through mobile phones and other intelligent terminals, improving the timeliness of event reporting and the efficiency of emergency disposal, and minimizing disaster losses. The main functions of the system include emergency reporting, daily zero report, notice and announcement management, early warning information reception, emergency disposal task management, historical event query, emergency resource query, instant messaging, GIS resource query and plotting, video uploading and other functions.

### Technical Field

The present invention relates to the field of emergency command, in particular to an intelligent terminal emergency command system based on a mobile phones or tablet computers.

### Background Art

In recent years, China has severe public security situation, natural disasters and accidents occur frequently, public health events and social security events happen constantly, and there are still threats to national security. The Chinese government attaches great importance to disposal of emergency events, and especially after the 2008 Wenchuan Earthquake, the State Council has put forward higher requirements for emergency disposal. In order to improve the emergency communication disposal ability for emergency events, the current situation of the communication industry is combed in the paper, and from the perspective of emergency complying with the current industry, an emergency command system based on mobile internet technology is established for exploration around the construction of informationized emergency command platform in the communication industry, so as to improve the command and dispatch ability of emergency communication of our country in an all-round way.

At present, most of the emergency systems established in the country are still based on PC fixed emergency platform, which cannot meet the needs of command and dispatch on the emergency site and rapid query of assistant decision-making information. A few emergency platforms have also developed emergency APP based on mobile phones, but the functions are limited, which cannot meet the functions of daily emergency duty, emergency reporting, large video uploading and instant messaging. The existing emergency platform is based on the manual telephone to report emergencies and the processing speed of information is slower, which cannot ensure the timeliness, accuracy and integrity of event information transmission. Moreover, when an emergency event occurs, because emergency resources cannot be quickly and comprehensively grasped, it is difficult to achieve rapid and real-time mobilization and not conducive to rapid arrival and use of emergency resources, seriously affecting the efficiency of emergency command and disposal.

### Contents of the Invention

At present, the existing emergency platforms in the country is based on manual telephone to report emergencies and the processing speed of information is slower, which cannot ensure the timeliness, accuracy and integrity of event information transmission; moreover, when an emergency event occurs, because emergency resources cannot be quickly and comprehensively grasped, it is difficult to achieve rapid and real-time mobilization and not conducive to rapid arrival and use of emergency resources, seriously affecting the efficiency of emergency command and disposal.

The present invention provides a B2C architecture mode, establishes an adapter on its server side, encapsulates service layer interface of the business system with EJB, provides APP application supporting the front end and realizes the service layer interface of available business functions to realize emergency reporting, daily zero report, emergency disposal and other functions through intelligent terminals, improving the timeliness of event reporting, thus improving the efficiency of emergency disposal and minimizing disaster losses.

The present invention is realized by the following schemes: an intelligent terminal emergency command system includes:

Emergency Reporting: It is realized that emergency on-duty personnel can report and check emergency information through various smart phones or tablet computers.

Management of Daily Zero Report: It is realized that emergency on-duty personnel can manage daily zero report information through smart phones or tablet computers.

Early Warning Information Receiving: Access to the database of the integrated application system, obtain the early warning information issued by the integrated application system, and realize the receiving and displaying of the early warning information on the intelligent terminal.

Management of Notice and Announcement: Users manage the release and receipt of all notices and announcement through smart phones and tablet computers.

Management of Emergency Disposal Tasks: Obtain the emergency disposal tasks issued by higher units, realize the display of emergency disposal tasks on intelligent terminals and the feedback of the implementation of tasks on intelligent terminals, and modify the task execution state.

Historical Event Information Query: It is realized that the historical event information is displayed on the intelligent terminals.

Emergency Resource Query: It is realized that the emergency communication resources are classified, displayed and queried on intelligent terminals.

Instant Messaging: Whether in peacetime or wartime, users can use instant messaging tools provided by the platform to communicate by real-time text, voice and video.

GIS Resource Query Plotting: Rescuers at the scene can access the geographic information system through mobile terminals, and can check the existing communication facilities and emergency resources in their current location in real time. Meanwhile, rescuers can use mobile devices to assistant in plotting on the map and reflect the scene situation to the command center.

Video Uploading: Rescuers at the scene use mobile terminals to shoot videos and upload them to platform servers in real time. Operators in the command center can watch the videos from the server to learn about the scene.

Furthermore, the emergency reporting mentioned also includes new events reporting, integrated reporting and updating. (1) New Events Reporting: the first reporting after an emergency event is defined as a new event reporting. After the reported information of the new events is studied and determined by the superior department, the reported event can be defined as the current event and the emergency response is initiated. (2) Event Updating: subordinate units can update reports on current events (events that initiate an emergency response after the study and determination of the superior department) and report the latest status of current events. (3) Integrated Reporting: users can receive the information reported by the subordinate units, and they also need to report the information to the higher units. Then when reporting information, the received information can be taken as an attachment to the reported information to the higher units.

Furthermore, the daily zero report management mentioned also includes daily zero report receiving, daily zero report collation and daily zero report submission.

Furthermore, the early warning information receiving mentioned also includes connection with the integrated application system, receiving of the emergency early warning information issued by the integrated application system in real time according to the CAP interface protocol of the early warning information, and response to the received early warning information in time.

Furthermore, the emergency resource query mentioned also includes network resources, such as base stations, optical cable equipment and hub buildings, as well as emergency vehicles, emergency equipment, emergency personnel, emergency reserves, emergency experts, etc.

Furthermore, the above instant messaging of which conversation type also includes single chat and group chat, supports instant messaging of rich media, can send text, voice, pictures, geographical location and name card and supports extended custom message types.

Furthermore, the above instant messaging's group chat also includes support for instant messaging among multiple people, support for large groups of 300 to 5000 people, and the same powerful instant messaging capability as the single chat, perfect group authority management, and the creation of private and public groups.

Furthermore, GIS resource query also includes peripheral analysis, optimal path analysis, traveling salesman analysis, service area analysis, nearest facility analysis and other functions. GIS plotting also includes local plotting and collaborative plotting.

Furthermore, the above GIS collaborative plotting of which collaborative plotting also includes the central control terminal depending on online collaborative plotting, displaying all plotting contents synchronously and realizing the collaborative operation of all mobile phone clients. After the completion of each operation, other clients will synchronize plotting contents, and realize the function of multi-client remote participation in collaborative consultation on the same map.

Furthermore, the video uploading mentioned also includes video editing: After selecting the uploaded videos, the basic information of the videos can be edited and correlated with emergencies. The basic information of the videos includes video titles, receiving units, related events, shooting location, etc.

Compared with the existing technology, the present invention has the following advantages and beneficial effects:

Based on mobile terminal emergency command system adopting mobile Internet technology, the present invention realizes mobile phones and tablet computers as effective supplement of mobile emergency, and expands mobile emergency platforms through the functions of emergency reporting, daily zero report, early warning information receiving, video uploading, collaborative plotting and emergency resource query, meets the needs of on-site emergency command and assistant decision-making information query, greatly improves the efficiency of emergency disposal and reduces the losses when disasters occur.

### BRIEF DESCRIPTION OF DRAWINGS

In order to make contents of the present invention understood more easily and clearly, the present invention is further described in detail in accordance with specific embodiments of the present invention and figures, where

FIG. 1 shows the architecture of an intelligent terminal emergency command system in an embodiment of the present invention.

FIG. 2 shows the structure of an intelligent terminal emergency command system in an embodiment of the present invention.

### EMBODIMENTS

The following contents are detailed descriptions for embodiments of the present invention combined with figures. The following embodiments are used to describe the present invention but are not used to limit the scope of the present invention.

### Embodiment 1

The application of intelligent terminal emergency command management system is a B2C architecture mode, establishes an adapter on its server side, encapsulates service layer interface of the business system with EJB, provides APP application supporting the front end and realizes the service layer interface of available business functions. Its client is an APP application installed on mobile devices. All business logic calls, data exchange and data synchronization generated during the operation are realized through the service layer of the departmental business system.

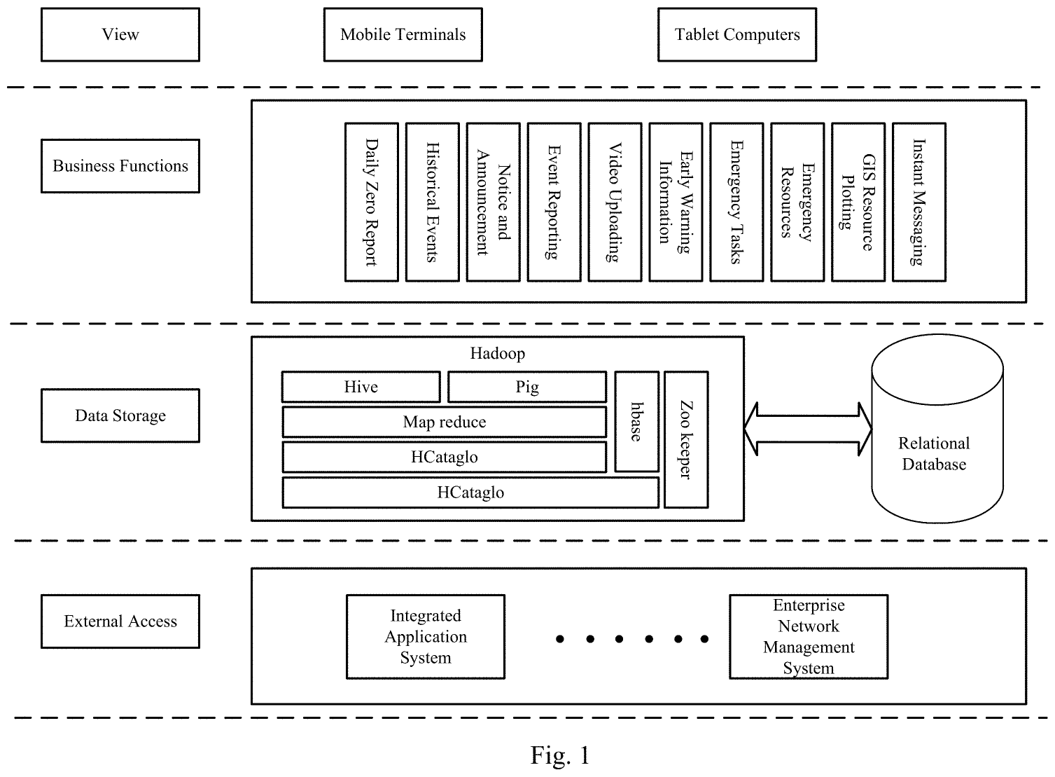

As shown in FIG. 1, the architecture of an intelligent terminal emergency command system provided by the present invention is divided into data access layer, data storage layer, business function layer and presentation layer from bottom to top. The above layers separately provide the corresponding data access and storage services, general supporting component services, basic support platform services to support development and operation, and specific business applications realized by underlying components and services, and show specific business applications to end users.

Presentation Layer: Intelligent terminals such as PDAs, tablet computers and mobile phones with Android system and IOS system are adopted.

Business Function Layer: The system uses the combination of public mobile communication network and emergency network access as a communication bearing platform to realize mobile access. It includes emergency reporting, daily zero report, notice and announcement management, early warning information receiving, emergency disposal task management, historical event query, emergency resource query, instant messaging, GIS resource query and plotting, video uploading and other functions.

Data Storage Layer: Data resource layer provides mechanism of data storage, management and resource access, and provides data and resource services for the above layers. Basic information database, GIS information database, emergency resource database, resource sharing database and emergency event database are mainly established. The structured data is mainly stored in oracle relational database, and unstructured and semi-structured data are stored in Hadoop big data platform, which supports the dynamic expansion of server storage capacity and provides big data analysis for command decision-making and emergency decision-making support. The big data platform adopts Hadoop+Hbase+Spark architecture, supports structured, unstructured and semi-structured data, backs dynamic expansion of file storage, and provides distributed storage of massive data and high-performance distributed computing framework. Data analysis such as data digging analysis and decision-making support is completed.

Data Access Layer: Access to the integrated application system, enterprise network management system and other external systems, and emergency resources, emergency basic information and other data are extracted from the integrated application system database and related systems.

### Embodiment 2

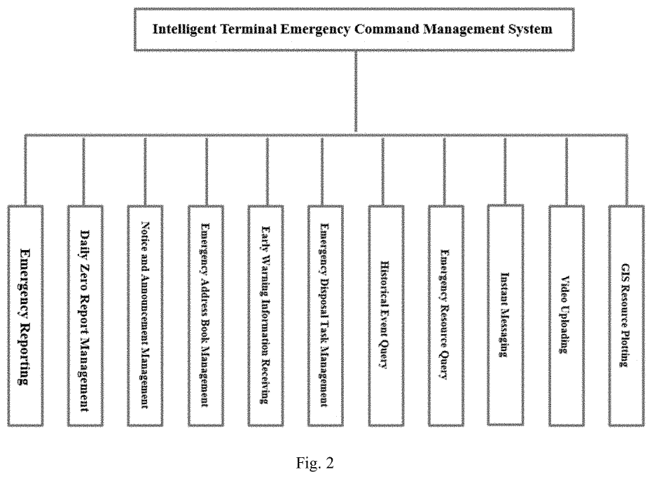

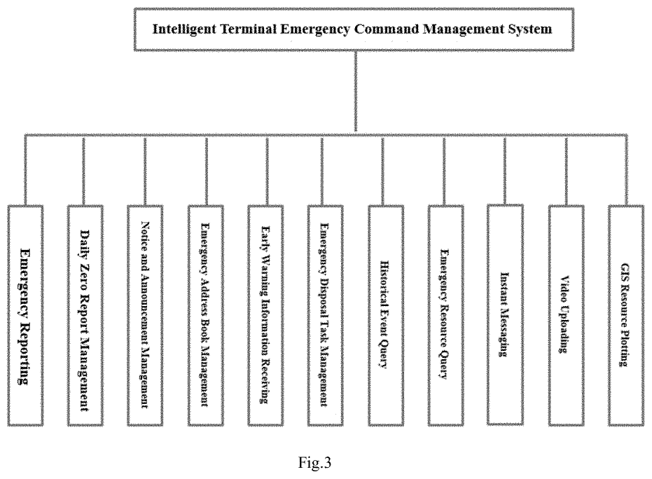

As shown in FIG. 2, the present invention provides the structural diagram of an intelligent terminal emergency command system, including emergency reporting, daily zero report, notice and announcement management, early warning information receiving, emergency disposal task management, historical event query, emergency resource query, instant messaging, GIS resource query and plotting, video uploading, etc. Specific functions are designed as follows:

Emergency Reporting: When an emergency event occurs, users fill in the event information in accordance with the prescribed format through intelligent terminals, and locate the event and report it to the superior department in charge in time. After the emergency information is reported to the superior department in charge, the emergency on-duty personnel of the emergency information receiving unit can be informed and reminded by voice to receive and deal with the emergency event in time, and receive and confirm information.

Management of Daily Zero Report: It is realized that the emergency on-duty personnel manage daily zero report information through smart phones or tablet computers, no event is used to achieve one-click reporting, and zero reporting management is used to achieve return of receiving zero report, settlement and other processing operations.

Early Warning Information Receiving: Access to the database of the integrated application system, obtain the early warning information issued by the integrated application system, and realize the receiving and displaying of the early warning information on the intelligent terminal.

Management of Notice and Announcement: Users manage the release and receipt of all notices and announcement through smart phones and tablet computers.

Management of Emergency Disposal Tasks: Task management function module realizes the unified query and supervision of tasks generated in command and dispatch and tasks generated in emergency drills. The assigned tasks can be queried by the title, status and assignment time of the tasks, and the tasks that are not executed or in execution can be supervised. Detailed information of tasks can be viewed, and feedback of task execution from task execution units can also be viewed. Task feedback function module realizes the viewing of tasks assigned by higher units and task progress feedback. Tasks can be queried by the unit responsible for assigning, task titles, assignment time, etc. Feedback information can be input through the feedback page for feedback, and the historical feedback records can be viewed.

Historical Event Information Query: It is realized that the historical emergency information can be queried on the intelligent terminal.

Emergency Resource Query: It is realized that the emergency communication resources can be classified, displayed and queried on intelligent terminals, including emergency vehicles, emergency equipment, emergency personnel, network resources, etc.

Instant Messaging: Whether in peacetime or wartime, users can use instant messaging tools provided by the platform to communicate by real-time text, voice and video.

GIS Resource Query Plotting: Rescuers at the scene can access the geographic information system through mobile terminals, and can check the existing communication facilities and emergency resources in their current location in real time. Meanwhile, rescuers can use mobile devices to assistant in plotting on the map and reflect the scene situation to the command center.

Video Uploading: Rescuers at the scene use mobile terminals to shoot videos and upload them to platform servers in real time. Operators in the command center can watch the videos from the server to learn about the scene.

The specific embodiments of the present invention described above do not constitute a limitation of the protection scope of the present invention. Any other corresponding changes and transformations made according to the technical concept of the present invention shall be included in the protection scope of the of the present invention claim.

1. An intelligent terminal emergency command system is characterized in that:
Emergency Reporting: It is realized that emergency on-duty personnel can report and check emergency information through various smart phones or tablet computers;
Management of Daily Zero Report: It is realized that emergency on-duty personnel can manage daily zero report information through smart phones or tablet computers;
Early Warning Information Receiving: Access to the database of the integrated application system, obtain the early warning information issued by the integrated application system, and realize the receiving and displaying of the early warning information on the intelligent terminal;
Management of Notice and Announcement: Users manage the release and receipt of all notices and announcement through smart phones and tablet computers;
Management of Emergency Disposal Tasks: Obtain the emergency disposal tasks issued by higher units, realize the display of emergency disposal tasks on intelligent terminals and the feedback of the implementation of tasks on intelligent terminals, and modify the task execution state;
Historical Event Information Query: It is realized that the historical event information is displayed on the intelligent terminals;
Emergency Resource Query: It is realized that the emergency communication resources are classified, displayed and queried on intelligent terminals;
Instant Messaging: Whether in peacetime or wartime, users can use instant messaging tools provided by the platform to communicate by real-time text, voice and video;
GIS Resource Query Plotting: Rescuers at the scene can access the geographic information system through mobile terminals, and can check the existing communication facilities and emergency resources in their current location in real time, Meanwhile, rescuers can use mobile devices to assistant in plotting on the map and reflect the scene situation to the command center;
Video Uploading: Rescuers at the scene use mobile terminals to shoot videos and upload them to platform servers in real time; Operators in the command center can watch the videos from the server to learn about the scene.

2. The intelligent terminal emergency command system described in the claim 1 is characterized in that the emergency reporting mentioned also includes new events reporting, integrated reporting and updating: (1) New Events Reporting: the first reporting after an emergency event is defined as a new event reporting, After the reported information of the new events is studied and determined by the superior department, the reported event can be defined as the current event and the emergency response is initiated; (2) Event Updating: subordinate units can update reports on current events (events that initiate an emergency response after the study and determination of the superior department) and report the latest status of current events; (3) Integrated Reporting: users can receive the information reported by the subordinate units, and they also need to report the information to the higher units, Then when reporting information, the received information can be taken as an attachment to the reported information to the higher units.

3. The intelligent terminal emergency command system described in the claim 1 is characterized in that the daily zero report management mentioned also includes daily zero report receiving, daily zero report collation and daily zero report submission.

4. The intelligent terminal emergency command system described in the claim 1 is characterized in that the early warning information receiving mentioned also includes connection with the integrated application system, receiving of the emergency early warning information issued by the integrated application system in real time according to the CAP interface protocol of the early warning information, and response to the received early warning information in time.

5. The intelligent terminal emergency command system described in the claim 1 is characterized in that the emergency resource query mentioned also includes network resources, such as base stations, optical cable equipment and hub buildings, as well as emergency vehicles, emergency equipment, emergency personnel, emergency reserves, emergency experts, etc.

6. The intelligent terminal emergency command system described in the claim 1 is characterized in that the above instant messaging of which conversation type also includes single chat and group chat, supports instant messaging of rich media, can send text, voice, pictures, geographical location and name card, and supports extended custom message types.

7. The intelligent terminal emergency command system described in the claim 6 is characterized in that the above instant messaging's group chat also includes support for instant messaging among multiple people, support for large groups of 300 to 5000 people, and the same powerful instant messaging capability as the single chat, perfect group authority management, and the creation of private and public groups.

8. The intelligent terminal emergency command system described in the claim 1 is characterized in that the above GIS resource query and plotting of which GIS resource query also includes peripheral analysis, optimal path analysis, traveling salesman analysis, service area analysis, nearest facility analysis and other functions, GIS plotting also includes local plotting and collaborative plotting.

9. The intelligent terminal emergency command system described in the claim 8 is characterized in that the above GIS plotting of which collaborative plotting also includes the central control terminal depending on online collaborative plotting, displaying all plotting contents synchronously and realizing the collaborative operation of all mobile phone clients, After the completion of each operation, other clients will synchronize plotting contents, and realize the function of multi-client remote participation in collaborative consultation on the same map.

10. The intelligent terminal emergency command system described in the claim 1 is characterized in that the video uploading mentioned also includes video editing: After selecting the uploaded videos, the basic information of the videos can be edited and correlated with emergencies, The basic information of the videos includes video titles, receiving units, related events, shooting location, etc.
